(19) United States
(12) Patent Application Publication
(10) Pub. No.: US 2018/0069910 A1
(43) Pub. Date: Mar. 8, 2018

(54) Systems and Methods for Live Voice-Over Solutions

(71) Applicant: Sonic IP, Inc., San Dieog, CA (US)

(72) Inventors: Horngwei Michael Her, St. James, NY (US); Joe Zhou, Brooklyn, NY (US); Qiang Wang, Shanghai (CN); Dong Xie, Shanghai (CN); Dongfa Liu, Shanghai (CN)

(73) Assignee: Sonic IP, Inc., San Diego, CA (US)

(21) Appl. No.: 15/698,542

(22) Filed: Sep. 7, 2017

Related U.S. Application Data
(60) Provisional application No. 62/384,638, filed on Sep. 7, 2016.

(51) Int. Cl. H04L 29/06; H04L 7/00; G06F 3/16

(52) U.S. Cl. CPC H04L 65/602; H04L 65/608; G06F 3/165; H04L 7/0008

(57) ABSTRACT

Systems and methods provide real time custom audio in accordance with embodiments of the invention. One method includes selecting a video stream from source multimedia content using a media server; recording a voice-over session audio recording for the video stream using the media server, where the voice-over session audio recording comprises real time custom audio for the video stream; synchronizing the timing of the voice-over session audio recording with the video stream to create a voice-over stream using the media server; and storing the voice-over stream as at least one voice-over audio stream for the source video channel using the media server.

### RELATED APPLICATIONS

The present invention claims priority to U.S. Provisional Patent Application Ser. No. 62/384,638 entitled “Systems and Methods for Live Voice-Over Solutions” to Her et al., filed Sep. 7, 2016. The disclosure of U.S. Provisional Patent Application Ser. No. 62/384,638 is herein incorporated by reference in its entirety.

### FIELD OF THE INVENTION

The present invention generally relates to video streaming and more specifically relates to digital video systems with real time custom audio.

### BACKGROUND

The term streaming media describes the playback of media on a playback device, where the media is stored on a server and continuously sent to the playback device over a network during playback. Typically, the playback device stores a sufficient quantity of media in a buffer at any given time during playback to prevent disruption of playback due to the playback device completing playback of all the buffered media prior to receipt of the next portion of media. Adaptive bit rate streaming or adaptive streaming involves detecting the present streaming conditions (e.g. the user's network bandwidth and CPU capacity) in real time and adjusting the quality of the streamed media accordingly. Typically, the source media is encoded at multiple bit rates and the playback device or client switches between streaming the different encodings depending on available resources.

Adaptive streaming solutions typically utilize either Hypertext Transfer Protocol (HTTP), published by the Internet Engineering Task Force and the World Wide Web Consortium as RFC 2616, or Real Time Streaming Protocol (RTSP), published by the Internet Engineering Task Force as RFC 2326, to stream media between a server and a playback device. HTTP is a stateless protocol that enables a playback device to request a byte range within a file. HTTP is described as stateless, because the server is not required to record information concerning the state of the playback device requesting information or the byte ranges requested by the playback device in order to respond to requests received from the playback device. RTSP is a network control protocol used to control streaming media servers. Playback devices issue control commands, such as “play” and “pause”, to the server streaming the media to control the playback of media files. When RTSP is utilized, the media server records the state of each client device and determines the media to stream based upon the instructions received from the client devices and the client's state.

In adaptive streaming systems, the source media is typically stored on a media server as a top level index file pointing to a number of alternate streams that contain the actual video and audio data. Each stream is typically stored in one or more container files. Different adaptive streaming solutions typically utilize different index and media containers. The Synchronized Multimedia Integration Language (SMIL) developed by the World Wide Web Consortium is utilized to create indexes in several adaptive streaming solutions including IIS Smooth Streaming developed by Microsoft Corporation of Redmond, Wash., and Flash Dynamic Streaming developed by Adobe Systems Incorporated of San Jose, Calif. HTTP Adaptive Bitrate Streaming developed by Apple Computer Incorporated of Cupertino, Calif. implements index files using an extended M3U playlist file (.M3U8), which is a text file containing a list of URIs that typically identify a media container file. The most commonly used media container formats are the MP4 container format specified in MPEG-4 Part 14 (i.e. ISO/IEC 14496-14) and the MPEG transport stream (TS) container specified in MPEG-2 Part 1 (i.e. ISO/IEC Standard 13818-1). The MP4 container format is utilized in IIS Smooth Streaming and Flash Dynamic Streaming. The TS container is used in HTTP Adaptive Bitrate Streaming.

The Matroska container is a media container developed as an open standard project by the Matroska non-profit organization of Aussonne, France. The Matroska container is based upon Extensible Binary Meta Language (EBML), which is a binary derivative of the Extensible Markup Language (XML). Decoding of the Matroska container is supported by many consumer electronics (CE) devices. The DivX Plus file format developed by DivX, LLC of San Diego, Calif. utilizes an extension of the Matroska container format (i.e. is based upon the Matroska container format, but includes elements that are not specified within the Matroska format).

To provide a consistent means for the delivery of media content over the Internet, the International Organization for Standardization (ISO) and the International Electrotechnical Commission (IEC) have put forth the Dynamic Adaptive Streaming over HTTP (DASH) standard. The DASH standard specifies formats for the media content and the description of the content for delivery of MPEG content using HTTP. In accordance with DASH, each component of media content for a presentation is stored in one or more streams. Each of the streams is divided into segments. A Media Presentation Description (MPD) is a data structure that includes information about the segments in each of the stream and other information needed to present the media content during playback. A playback device uses the MPD to obtain the components of the media content using adaptive bit rate streaming for playback.

### SUMMARY OF THE INVENTION

Systems and methods provide real time custom audio in accordance with embodiments of the invention. One method includes selecting a video stream from source multimedia content using a media server; recording a voice-over session audio recording for the video stream using the media server, where the voice-over session audio recording comprises real time custom audio for the video stream; synchronizing the timing of the voice-over session audio recording with the video stream to create a voice-over stream using the media server; and storing the voice-over stream as at least one voice-over audio stream for the source video channel using the media server.

In a further embodiment, the source multimedia content further comprises at least one preexisting audio stream.

In another embodiment, further comprising previewing the voice-over session by playing the voice-over audio recording and the at least one preexisting audio stream using the media server.

In a still further embodiment, further comprising mixing the recorded voice-over session audio recording with the at least one preexisting audio stream.

In still another embodiment, the at least one preexisting audio stream is commentary in a first language and the voice-over stream is commentary in a second language.

In a yet further embodiment, further comprising replacing the commentary in the source multimedia content in the first language with the commentary in the second language by removing the at least one preexisting audio stream in the first language and inserting the voice-over stream in the second language using the media server.

In yet another embodiment, the voice-over session is recorded using a mobile device.

In a further embodiment again, further comprising recording the voice-over session at a delay relative to the source video channel.

In another embodiment again, further comprising sending at least information describing the voice-over stream to a manifest server, wherein the manifest server generates a top level index file to identify the voice-over stream.

In yet another embodiment, comprising memory configured to store multimedia content, where the multimedia content includes a source video; and a processor; wherein the processor is configured by a voice-over application to: select a video stream from the multimedia content; record a voice-over video session audio recording for the video stream, where the voice-over session audio recording comprises real time custom audio for the video stream; synchronize the timing of the voice-over session audio recording with the video stream to create a voice-over stream; and store the voice-over stream as at least one voice-over audio stream for the source video channel.

In a further additional embodiment, the processer is further configured to preview the voice-over session by playing the voice-over audio recording and the at least one preexisting audio stream using the media server.

In another additional embodiment, the processor is further configured to mix the recorded voice-over session with the at least one preexisting audio stream.

In a still yet further embodiment, the processor is further configured to replace the commentary in the source multimedia content in the first language with the commentary in the second language by removing the one or more preexisting audio stream in the first language and inserting the voice-over stream in the second language.

In still yet another embodiment, the processor is further configured to record the voice-over session at a delay relative to the source video channel.

In a further embodiment, the processor is further configured to send at least information describing the voice-over stream to a manifest server, wherein the manifest server generates a top level index file to identify the voice-over stream.

### BRIEF DESCRIPTION OF THE DRAWINGS

FIG. 1 is a diagram illustrating a network diagram of an adaptive bitrate streaming system in accordance with an embodiment of the invention.

FIG. 2 is a diagram illustrating a playback device of an adaptive bitrate streaming system in accordance with an embodiment of the invention.

FIG. 3 is a diagram illustrating a server of an adaptive bitrate streaming system in accordance with an embodiment of the invention.

FIG. 4 is a flowchart illustrating a voice-over channel process in accordance with an embodiment of the invention.

FIG. 5 is a screen shot illustrating a log in screen for a voice-over application in accordance with an embodiment of the invention.

FIG. 6 is a screen shot illustrating a game list for a voice-over application in accordance with an embodiment of the invention.

FIG. 7 is a screen shot illustrating a voice-over session for a voice-over application in accordance with an embodiment of the invention.

FIG. 8 is a screen shot illustrating a voice-over session for a voice-over application in accordance with an embodiment of the invention.

### DETAILED DESCRIPTION

Turning now to the drawings, systems and methods for providing real time custom audio for video streaming in accordance with many embodiments of the invention are illustrated. In several embodiments of the invention, the custom audio can be audio commentary such as a recorded voice-over session for a source video channel. A source video channel can include a single video stream or a set of alternative video streams that can be utilized to perform adaptive bitrate streaming and can contain several audio streams including (but not limited to) background sounds and/or preexisting audio commentary. Generally, the source video channel is audio and/or video being streamed in real time. In many embodiments, a recorded voice-over session can be stored as a separate audio stream. In various embodiments, the format for this stream can be any of the file formats utilized within the NeuLion Adaptive streaming system distributed by NeuLion of Plain View, N.Y., HTTP Live Streaming (HLS) specified by Apple, Inc. of Cupertino, Calif., and/or Dynamic Adaptive Streaming over HTTP (DASH) specified by the Motion Picture Experts Group and published as ISO/IEC 23009-1:2012. In other embodiments, any of a variety of formats can be utilized as appropriate to the requirements of a given application.

The recorded voice-over session can then be synchronized with the source video channel to create a new voice-over audio stream which can include components from the source video channel in addition to audio data captured during the recorded voice-over session. As an illustrative example, a source video channel can include a first audio stream containing background sounds and a second audio stream containing an English language commentary. An audio stream recorded during a voice-over session can include commentary in another language. The created new voice-over audio stream can include the background sounds, the commentary in another language, but remove the English language commentary.

In many embodiments of the invention, recorded voice-over sessions can be created through a software application on a phone (such as but not limited to an iPhone and/or Android phone) and/or a tablet or through software on a laptop or a personal computer. Generally, this application and/or software has UI widgets to control the mixed volume between the audio data captured via a microphone during a recorded voice-over session and the background sounds in an audio stream of the source video channel. In various embodiments, a short time delay (for example a 5 second time delay) can be inserted into the stream to enable a user to listen to an existing audio stream and then speak into the microphone to provide commentary for the same portion of the source video channel. The delay can be particularly useful when providing audio streams in an alternative language. Generally, this can allow the sound mixing of the voice-over session to be tested before the new voiced-over audio stream is created.

### Adaptive Streaming System Architectures

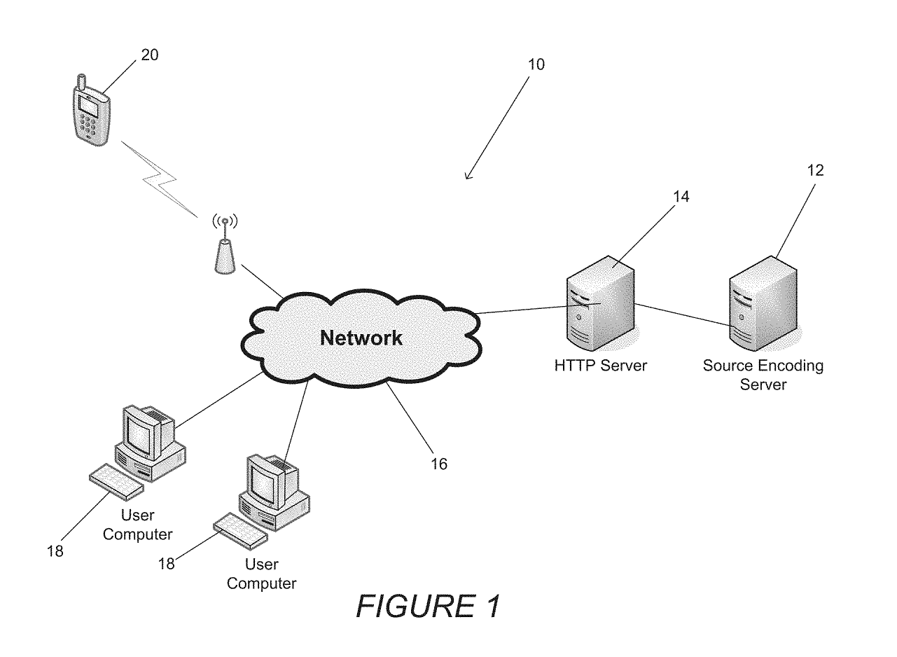

Turning now to the FIG. 1, an adaptive streaming system including playback devices that provide real time video streaming in accordance with an embodiment of the invention is illustrated. The adaptive streaming system 10 includes a source encoder 12 configured to encode source media as a number of alternative streams. In the illustrated embodiment, the source encoder is a server. In other embodiments, the source encoder can be any processing device including a processor and sufficient resources to perform the transcoding of source media (including but not limited to video, audio, and/or subtitles). In some embodiments, the server encoder 12 is a system of two or more servers that encode the source media into a number of alternative streams. In many of these embodiments, a first one of the two or more servers encodes the media content to create a stream with the highest maximum bit rate that is typically the stream that includes the highest quality video content. The remaining ones of the two more servers generate the other alternative streams encoded at lower maximum bitrates and/or streams that include video content having differing parameters. Typically, the source encoding server 12 generates a top level index to a plurality of container files containing the streams and/or metadata information, at least a plurality of which are alternative streams. Alternative streams are streams that encode the same media content in different ways. In many instances, alternative streams encode media content (such as, but not limited to, video content and/or audio content) at different maximum bitrates. In a number of embodiments, the alternative streams of video content are encoded with different resolutions and/or at different frame rates. The top level index file and the container files are uploaded to an HTTP server 14. A variety of playback devices can then use HTTP or another appropriate stateless protocol to request portions of the top level index file, other index files, and/or the container files via a network 16 such as the Internet. Furthermore, Real-Time Messaging Protocol (RTMP) may be used to request and transmit the various streams carrying the various different portions of the media content (i.e. video stream, audio streams, and/or subtitle streams).

In the illustrated embodiment, playback devices include personal computers 18, CE players, and mobile phones 20. In other embodiments, playback devices can include consumer electronics devices such as DVD players, Blu-ray players, televisions, set top boxes, video game consoles, tablets, and other devices that are capable of connecting to a server via HTTP and playing back encoded media. Although a specific architecture is shown in FIG. 1, any of a variety of architectures including systems that perform conventional streaming and not adaptive bitrate streaming can be utilized that enable playback devices to request portions of the top level index file and the container files in accordance with embodiments of the invention.

### Playback Devices

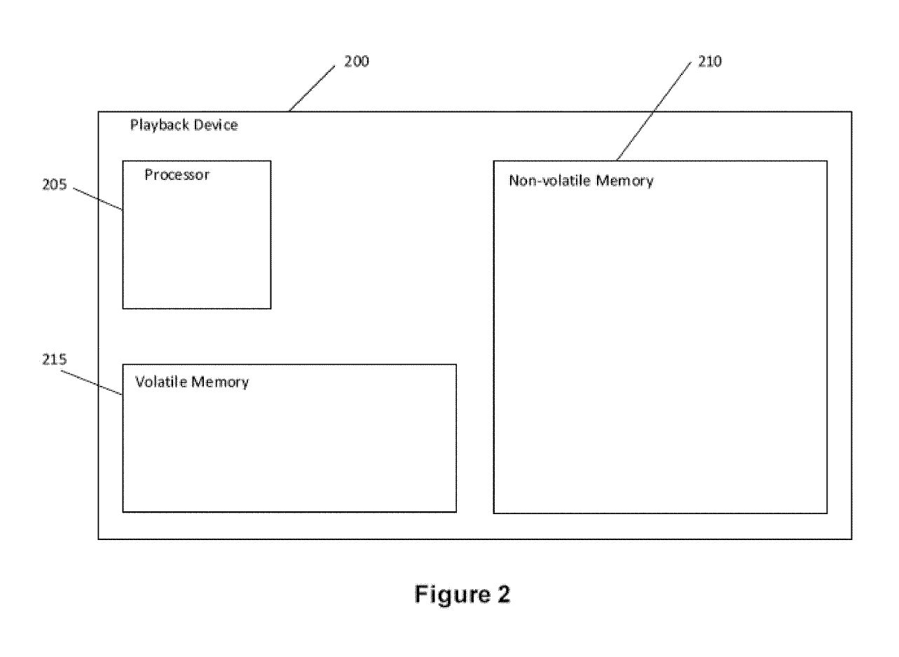

Some processes for providing methods and configuring systems in accordance with embodiments of this invention are executed by a playback device. The relevant components in a playback device that can perform the processes in accordance with an embodiment of the invention are shown in FIG. 2. One skilled in the art will recognize that playback device may include other components that are omitted for brevity without departing from described embodiments of this invention. The playback device 200 includes a processor 205, a non-volatile memory 210, and a volatile memory 215. The processor 205 is a processor, microprocessor, controller, or a combination of processors, microprocessor, and/or controllers that performs instructions stored in the volatile 215 or non-volatile memory 210 to manipulate data stored in the memory. The non-volatile memory 210 can store the processor instructions utilized to configure the playback device 200 to perform processes including processes in accordance with embodiments of the invention and/or data for the processes being utilized. In accordance with some embodiments, these instructions are included in a playback application that performs the playback of media content on a playback device. In accordance with various embodiments, the playback device software and/or firmware can be stored in any of a variety of non-transitory computer readable media appropriate to a specific application.

### Servers

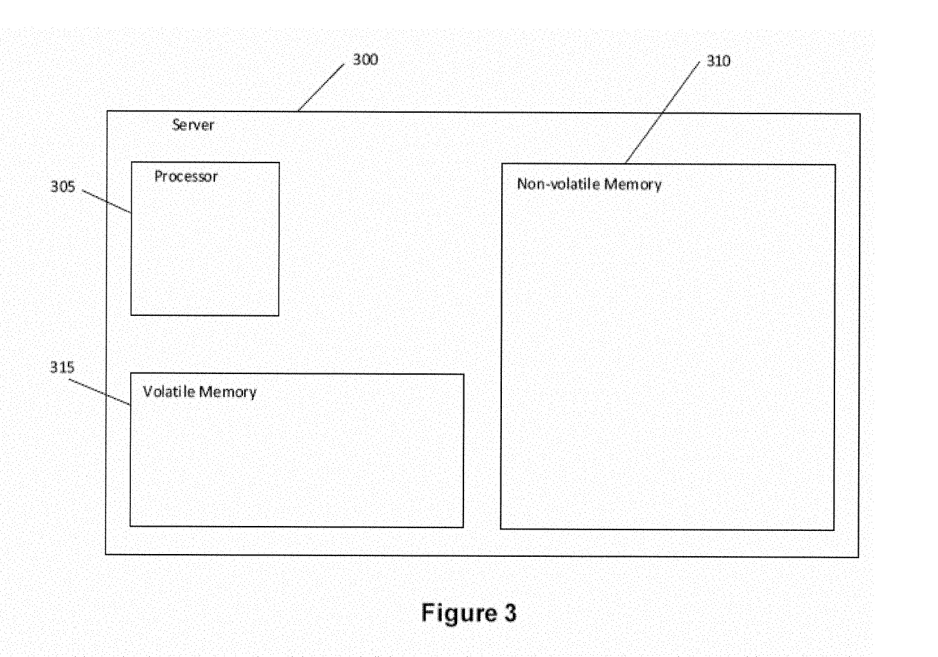

Various processes for providing methods and systems in accordance with embodiments of this invention are executed by the HTTP server; source encoding server; and/or local and network time servers. The relevant components in a server that performs one or more of these processes in accordance with embodiments of the invention are shown in FIG. 3. One skilled in the art will recognize that a server may include other components that are omitted for brevity without departing from the described embodiments of this invention. The server 300 includes a processor 305, a non-volatile memory 310, and a volatile memory 315. The processor 305 is a processor, microprocessor, controller, or a combination of processors, microprocessor, and/or controllers that performs instructions stored in the volatile 315 or non-volatile memory 310 to manipulate data stored in the memory. The non-volatile memory 310 can store the processor instructions utilized to configure the server 300 to perform processes including processes in accordance with embodiments of the invention and/or data for the processes being utilized. In accordance with some embodiments, instructions to perform encoding of media content are part of an encoding application. In accordance with various embodiments, the server software and/or firmware can be stored in any of a variety of non-transitory computer readable media appropriate to a specific application. Although a specific server is illustrated in FIG. 3, any of a variety of server configured to perform any number of processes can be utilized in accordance with embodiments of the invention. Voice-over processes in accordance with many embodiments of the invention are described below.

### Voice-Over Processes

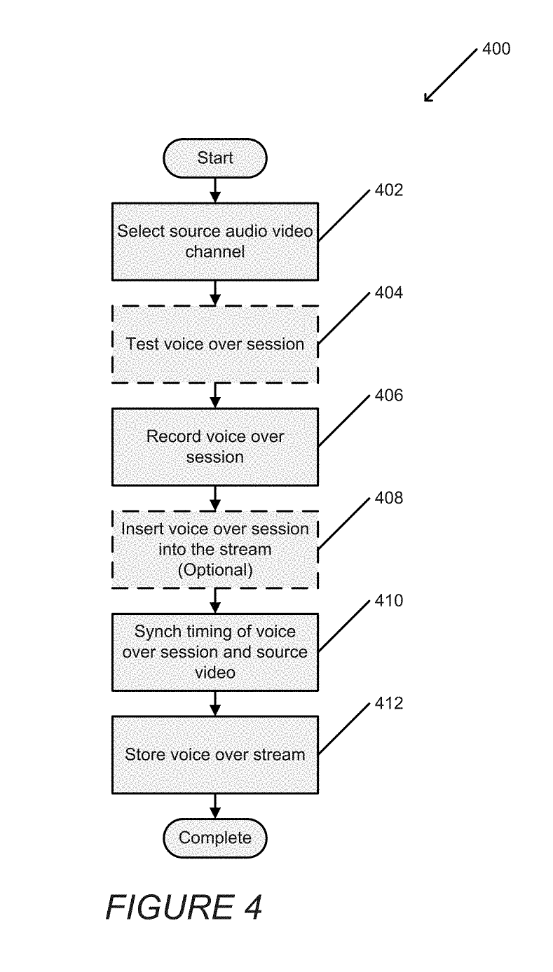

Processes for generating voice-over channels in accordance with various embodiments of the invention are illustrated in FIG. 4. The process 400 includes selecting (402) source content including at least one audio and at least one video stream. The source content can include (but is not limited to) a live sports game, a concert, a lecture, and/or any other live streaming event. In several embodiments, the voice-over session can optionally be tested (404) with a previewing of the mix of the voice-over audio levels with the source content audio stream audio levels.

A voice-over session can be recorded (406). In various embodiments, a voice-over session can be recorded using an application on a mobile device such as (but not limited to) tablet or a phone. In other embodiments, a voice-over session can be recorded using software on a computer. In many embodiments, the voice-over session is recorded while the source content video and audio are played back and the voice-over session audio content is delayed relative to the video content to which it corresponds. Therefore, the timing of the voice-over session audio content is adjusted to enable synchronization with the source video content (often being live streamed), and/or portions of the source content audio stream with which the voice-over session audio content may be mixed. The recorded voice-over session can (optionally) be mixed (408) with audio content from the source content audio stream. In many embodiments, the voice-over session is simply saved as a separate audio stream that can be played back and/or mixed with another audio stream and played back by a playback device. The timing of the voice-over session audio stream and the source content video stream can be synchronized (410). In many embodiments of the invention, portions of the source content audio stream can be removed from the source content, for example (but not limited to) an English language commentary can be removed and the remaining audio content mixed with voice-over session audio content to provide commentary in a different language. The voice-over stream is stored (412) in a location in which it is accessible for streaming via playback devices. In many embodiments, information concerning the voice-over stream can be provided to a manifest server that is configured to dynamically generate manifest or top level index files identifying content (including voice-over streams) that playback devices can request during a streaming session. In various embodiments of the invention, a voice-over stream can be selected for streaming via a user interface of a software application executing on a playback device. Although a variety of processes for generating voice-over streams are described above with respect to FIG. 4, any of a variety of processes capable of inserting audio into a live stream in real time can be utilized as appropriate to the requirements of specific applications in accordance with various embodiments of the invention.

### User Interfaces for Voice-Over Applications

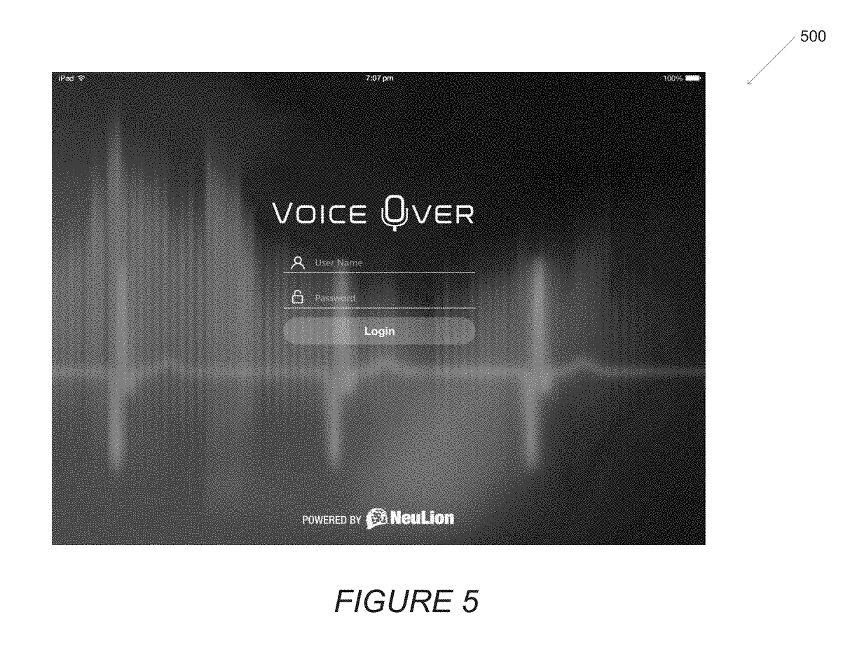

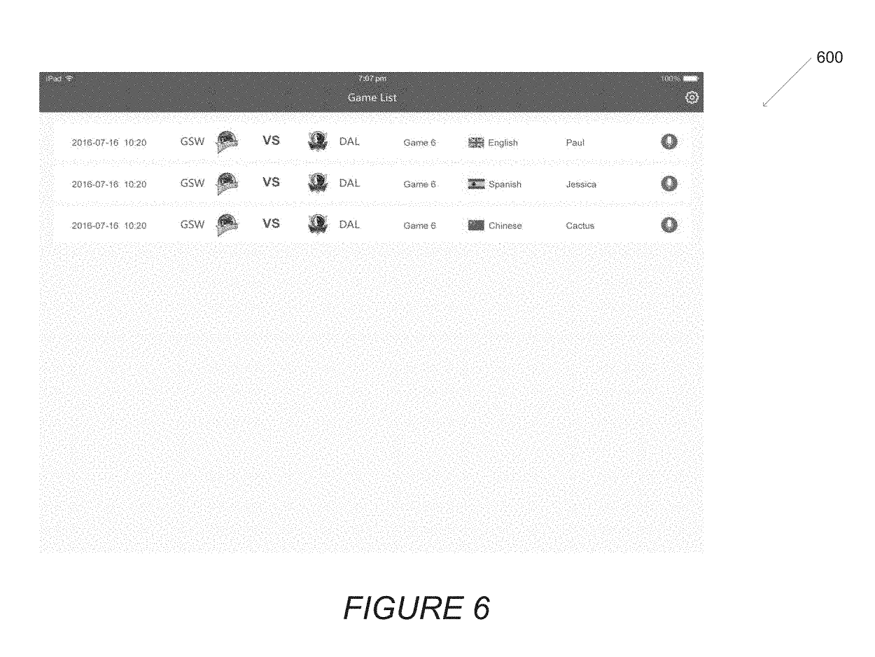

User interfaces for software and/or applications in accordance with various embodiments of the invention are illustrated in FIGS. 5, 6, and 7. A login screen 500 is illustrated in FIG. 5, which opens the application and/or software by using a username and/or password. A game list 600 is illustrated in FIG. 6. Game list 600 is an illustrative example of voice-over channels with commentary for the same source content displayed in different languages. This list is merely illustrative and the source content could alternatively include (but is not limited to) concerts, lectures, and/or alternative live streaming events. Additionally, voiced-over channels can contain alternative differentiating characteristics in addition to language including (but not limited to) person recorded during voice-over session, team of people recorded during voice-over session, genre (such as drama, comedy etc.) and/or recommended viewing age (such as all ages, adult only, etc.).

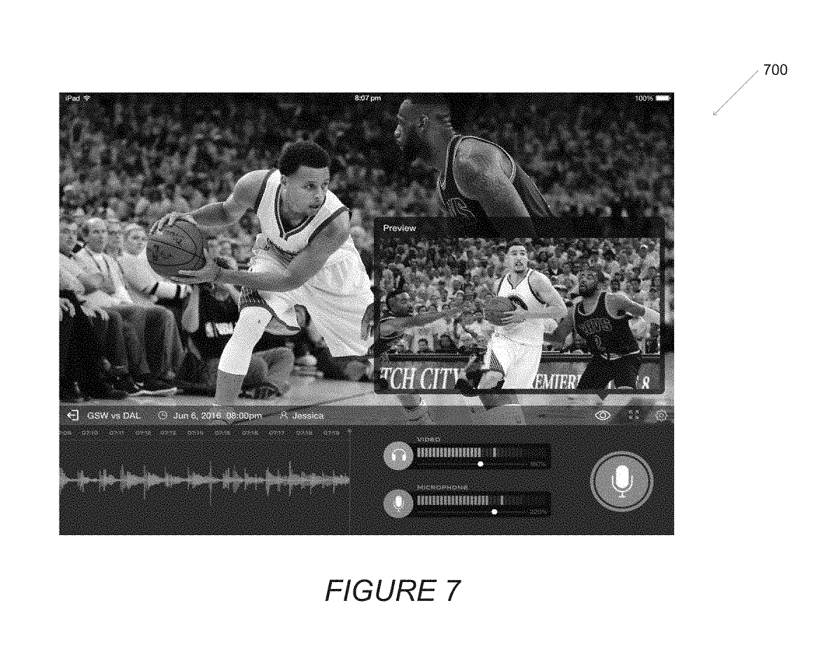

A voice-over session application 700 user interface in accordance with an embodiment of the invention is illustrated in FIG. 7. A main video area plays a live stream of the source content, which in the illustrated embodiment is a live video stream of a basketball game. In various embodiments of the invention, video and microphone volume meters show the volume of the source audio and the recorded voice-over audio. A waveform display shows the timeline with the source content and voice-over session audio history. In several embodiments of the invention, the slider control under the video and microphone meters can determine the mix of the source and recorded audio. A ‘Record’ button can be utilized to start the recording.

A preview button can be selected to open the preview video window and to provide test commentary for a test voice-over session. In an illustrative example, preview audio/video can be delayed 5 seconds. This can allow adjustments to be made to the final levels of the mixed audio. In many embodiments, once the audio levels have been adjusted, the preview window can be closed and recording can continue.

It should readily be apparent to one having ordinary skill in the art that the user interface of the voice-over session application illustrated in FIG. 7 is merely illustrative and other applications with a variety of other features can be utilized as appropriate to requirements of the invention.

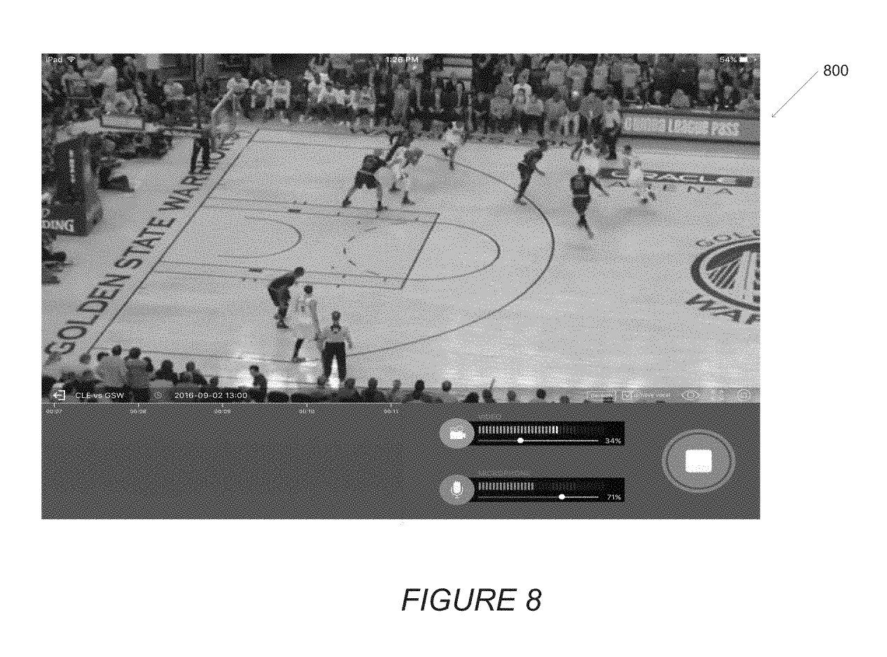

A voice-over session application 800 user interface in accordance with an embodiment of the invention is illustrated in FIG. 8. A main video area plays a live stream of the source content, which in the illustrated embodiment is a live video stream of a basketball game. In various embodiments of the invention, video and microphone volume meters show the volume of the source audio and the recorded voice-over audio. A waveform display shows the timeline with the source content and voice-over session audio history. In several embodiments of the invention, the slider control under the video and microphone meters can determine the mix of the source and recorded audio. A ‘Record’ button can be utilized to start the recording. The interface also includes a language display button that allows the user to indicate the language in which the audio is being recorded. This will allow multiple commenters in various languages to generate voice-over audio for the video content and allow users of such voice-overs to know the language in which each voice-over was recorded.

Furthermore, the interface may include a statistics window that provides a display of statistics relevant to the video being played back that are synchronized with the video being displayed to assist a commentator in generating the voice-over. In accordance with some other embodiments, the application may support transmission and/or directing of the streaming of video content to a television or other display connected to a same network as the playback device to allow for better viewing of the video content by the commentator.

It should readily be apparent to one having ordinary skill in the art that the user interface of the voice-over session application illustrated in FIG. 8 is merely illustrative and other applications with a variety of other features can be utilized as appropriate to requirements of the invention.

Although the present invention has been described in certain specific aspects, many additional modifications and variations would be apparent to those skilled in the art. It is therefore to be understood that the present invention may be practiced otherwise than specifically described, including various changes in the implementation such as utilizing encoders and decoders that support features beyond those specified within a particular standard with which they comply, without departing from the scope and spirit of the present invention. Thus, embodiments of the present invention should be considered in all respects as illustrative and not restrictive.

What is claimed is:

1. A method for recording audio for use in adaptive bitrate streaming systems, comprising:
selecting a video stream from source multimedia content using a media server;
recording a voice-over session audio recording for the video stream using the media server, where the voice-over session audio recording comprises real time custom audio for the video stream;
synchronizing the timing of the voice-over session audio recording with the video stream to create a voice-over stream using the media server; and
storing the voice-over stream as at least one voice-over audio stream for the source video channel using the media server.

2. The method of claim 1, wherein the source multimedia content further comprises at least one preexisting audio stream.

3. The method of claim 2, further comprising previewing the voice-over session by playing the voice-over audio recording and the at least one preexisting audio stream using the media server.

4. The method of claim 2, further comprising mixing the recorded voice-over session audio recording with the at least one preexisting audio stream.

5. The method of claim 2, wherein the at least one preexisting audio stream is commentary in a first language and the voice-over stream is commentary in a second language.

6. The method of claim 5, further comprising replacing the commentary in the source multimedia content in the first language with the commentary in the second language by removing the at least one preexisting audio stream in the first language and inserting the voice-over stream in the second language using the media server.

7. The method of claim 2, wherein the voice-over session is recorded using a mobile device.

8. The method of claim 2, wherein the video stream is a live stream.

9. The method of claim 8, further comprising recording the voice-over session at a delay relative to the source video channel.

10. The method of claim 2, further comprising sending at least information describing the voice-over stream to a manifest server, wherein the manifest server generates a top level index file to identify the voice-over stream.

11. A media server, comprising:
memory configured to store multimedia content, where the multimedia content includes a source video; and
a processor;
wherein the processor is configured by a voice-over application to:
select a video stream from the multimedia content;
record a voice-over video session audio recording for the video stream, where the voice-over session audio recording comprises real time custom audio for the video stream;
synchronize the timing of the voice-over session audio recording with the video stream to create a voice-over stream; and
store the voice-over stream as at least one voice-over audio stream for the source video channel.

12. The media server of claim 11, wherein the source multimedia content further comprises at least one preexisting audio channel.

13. The media server of claim 12, wherein the processer is further configured to preview the voice-over session by playing the voice-over audio recording and the at least one preexisting audio stream using the media server.

14. The media server of claim 12, wherein the processor is further configured to mix the recorded voice-over session with the at least one preexisting audio stream.

15. The media server of claim 12, wherein the at least one preexisting audio stream is commentary in a first language and the voice-over stream is commentary in a second language.

16. The media server of claim 15, wherein the processor is further configured to replace the commentary in the source multimedia content in the first language with the commentary in the second language by removing the one or more preexisting audio stream in the first language and inserting the voice-over stream in the second language.

17. The media server of claim 12, wherein the voice-over session is recorded using a mobile device.

18. The media server of claim 12, wherein the source video channel is a live stream.

19. The media server of claim 18, wherein the processor is further configured to record the voice-over session at a delay relative to the source video channel.

20. The media server of claim 12, wherein the processor is further configured to send at least information describing the voice-over stream to a manifest server, wherein the manifest server generates a top level index file to identify the voice-over stream.
